(19) United States
(12) Patent Application Publication
(10) Pub. No.: US 2020/0291752 A1
(43) Pub. Date: Sep. 17, 2020

(54) Safety Apparatus for an Actuator

(71) Applicant: Infinity Oilfield Services Limited, Aberdeen (GB)

(72) Inventors: Andrew MACGILL, Gourdon (GB); Andrew MACKAY, Gourdon (GB); Craig BANKS, Gourdon (GB)

(73) Assignee: Infinity Oilfield Services Limited, Aberdeen (GB)

(21) Appl. No.: 16/770,415

(22) PCT Filed: Dec. 4, 2018
(86) PCT No.: PCT/GB2018/053504

§ 371 Date: Jun. 5, 2020

(30) Foreign Application Priority Data
Dec. 5, 2017 (GB) 1720297.9

(51) Int. Cl. E21B 41/00; F15B 20/00; F16P 1/02

(52) U.S. Cl. CPC E21B 41/0021; F16P 1/02; F15B 20/00

(57) ABSTRACT

A safety apparatus (10) for an actuator (12) comprises a housing arrangement including an outer housing (14) and an inner housing (22). The outer housing (14) comprises a base portion (18) and a wall portion (20) extending from the base portion (18). The housing arrangement defines an enclosure for encompassing an end portion (16) of the actuator (12) and is configured to form a barrier for containing stored energy and/or one or more component of the actuator (12) released in the event of actuator failure. The housing arrangement is retained by a securement arrangement (42). An indicator arrangement (30) is provided in order to provide a visual indication that failure of the actuator (12) has occurred.

### FIELD

This relates to a safety apparatus for an actuator.

### BACKGROUND

Actuators are used in a vast array of applications and environments. In the oil and gas exploration and production industry, for example, actuators are used in numerous applications in order to control equipment and often form key components in the safety and operational systems of an oil and gas installation.

Actuators used in oil and gas installations are subject to a number of significant challenges. For example, actuators used in both offshore and onshore oil and gas installations may be exposed to extremes of temperature, while offshore installations are also subject to the corrosive effects from the marine environment. As such, it is important that actuators used in such environments are subject to regular inspection, repair and maintenance regimes in order to avoid or at least reduce the incidence of actuator failure. Even where such inspection, repair and maintenance regimes are carried out on a regular basis, however, actuator failure remains a risk.

It will be recognised that many actuators used in oil and gas installations are large constructions with high load capacity, such that actuator failure results in a significant release of stored energy.

In one failure mode, the failure of an actuator may result in axial ejection of one or more actuator component, such as the actuator spring, end cap bolts, end caps and/or tie rod. In another failure mode, the failure of an actuator may result in lateral, e.g. radial, ejection of one or more actuator component.

While any actuator failure poses a risk, the proximity of actuators to personnel working areas means that actuator failure represents a significant risk to personnel and other equipment.

An additional challenge posed by oil and gas installations towards the end of their operational life and/or which are in the process of being decommissioned is that repair and/or replacement of a given actuator may be impractical or uneconomical. Nevertheless, there remains a need to reduce the risk posed by failure of such actuators.

### SUMMARY

According to a first aspect, there is provided a safety apparatus for an actuator, comprising:

a housing arrangement configured for location on an actuator, the housing arrangement comprising an outer housing comprising a base portion and a wall portion extending from the base portion, the housing arrangement defining an enclosure for encompassing an end portion of the actuator and configured to form a barrier for containing one or more component of the actuator and/or release of stored energy in the event of actuator failure.

Beneficially, embodiments of the safety apparatus reduce the risk to personnel and equipment which may otherwise result from the ejection of components and/or release of stored energy caused by actuator failure. This is achieved by providing a safety apparatus configured to contain one or more component of the actuator in the event of actuator failure, such that ejection of the one or more component may be prevented.

The housing arrangement may be modular in construction.

The outer housing may comprise or take the form of a bag.

The outer housing may comprise and/or may be at least partially constructed from a fabric material.

Beneficially, an outer housing which comprises and/or is at least partially constructed from a fabric material provides a safety apparatus which is flexible and/or lightweight. It is envisaged, for example, that the outer housing may be configured for location in an offshore kit bag or like container, permitting transport of the safety apparatus by helicopter or other conventional means; obviating the requirement for specialist transport at significant expense and which typically has limited availability.

The outer housing may be reconfigurable between a first configuration and a second, larger, configuration. The first configuration may define a storage configuration. The second configuration may define a deployment configuration suitable for locating the outer housing on the actuator.

The outer housing may comprise and/or may be at least partially constructed from a synthetic fibre material.

The outer housing may comprise and/or may be at least partially constructed from an aramid material.

The outer housing may comprise and/or may be at least partially constructed from a para-aramid material.

The outer housing may comprise and/or may be at least partially constructed from Kevlar® or like material.

Beneficially, an outer housing constructed from a para-aramid material, such as Kevlar® or like material, provides a barrier capable of containing one or more components of the actuator ejected in the event of actuator failure.

The outer housing may comprise and/or may be at least partially constructed from Twaron® or like material.

Beneficially, an outer housing constructed from Twaron® or like material provides a barrier capable of containing one or more components of the actuator ejected in the event of actuator failure. An outer housing constructed from a para-aramid material, such as Twaron® or like material, also provides an outer housing which is thermally stable and resistant to chemical attack, and which is thus suited to the harsh environment of an oil and gas installation.

The outer housing may comprise and/or may be at least partially constructed from a meta-aramid material.

The outer housing may comprise and/or may be at least partially constructed from Nomex® or like material.

Beneficially, an outer housing constructed from a meta-aramid material, such as Nomex® or like material, provides a barrier capable of containing one or more components of the actuator ejected in the event of actuator failure. An outer housing constructed from a meta-aramid material, such as Nomex® or like material, also provides an outer housing which is fire resistant, and which is thus suited to the harsh environment of an oil and gas installation.

The outer housing may comprise and/or may be at least partially constructed from a composite material, such as glass fibre composite or carbon fibre composite, and/or a polymeric material, such as Polyether Ether Ketone (PEEK).

Beneficially, an outer housing constructed from a composite material, such as glass fibre composite or carbon fibre composite, and/or a polymeric material, such as Polyether Ether Ketone (PEEK) may provide a rigid outer housing.

The outer housing may be configured to resist an impact force. For example, the outer housing may comprise and/or may be at least partially constructed from an impact resistant material, such as a rubber material, a foam material or the like. In particular, but not exclusively, the outer housing may comprise a vinyl nitrile polymer foam compound material or like material.

The outer housing may comprise a unitary construction. For example, the outer housing may be constructed as a moulded component or a continuously wound component.

Alternatively, the outer housing may comprise a modular construction.

The outer housing may comprise a plurality of layers of material, such as the materials described above.

The safety apparatus may comprise a plurality of the outer housings. For example, the safety apparatus may comprise a first outer housing for location about a first end portion of the actuator and a second outer housing for location about a second end portion of the actuator.

The housing arrangement may comprise an inner housing.

In use, the inner housing may form an armour layer of the safety apparatus.

The inner housing may be configured for location within the outer housing.

The inner housing may be offset from the outer housing so as to define a cavity therebetween.

The inner housing and the outer housing may be dimensioned so that the cavity may house an indicator arrangement, as will be described further below.

The inner housing may comprise a base portion.

The inner housing may comprise a wall portion.

The wall portion of the inner housing may extend from the base portion of the inner housing.

The inner housing may comprise or take the form of a bag.

The inner housing may comprise and/or may be at least partially constructed from a fabric material.

Beneficially, an inner housing which comprises and/or is at least partially constructed from a fabric material provides an safety apparatus which is flexible and/or lightweight. It is envisaged, for example, that the inner housing may be configured for location in an offshore kit bag or like container, permitting transport of the safety apparatus by helicopter or other conventional means; obviating the requirement for specialist transport at significant expense and which typically has limited availability.

The inner housing may be reconfigurable between a first configuration and a second, larger, configuration. The first configuration may define a storage configuration. The second configuration may define a deployment configuration suitable for locating the inner housing on the actuator.

The inner housing may comprise and/or may be at least partially constructed from a synthetic fibre material.

The inner housing may comprise and/or may be at least partially constructed from an aramid material.

The inner housing may comprise and/or may be at least partially constructed from a para-aramid material.

The inner housing may comprise and/or may be at least partially constructed from Kevlar® or like material.

Beneficially, an inner housing constructed from a para-aramid material, such as Kevlar® or like material, provides a barrier capable of containing one or more components of the actuator ejected in the event of actuator failure.

The inner housing may comprise and/or may be at least partially constructed from Twaron® or like material.

Beneficially, an inner housing constructed from a para-aramid material, such as Twaron® or like material, provides a barrier capable of containing one or more components of the actuator ejected in the event of actuator failure. An inner housing constructed from a para-aramid material, such as Twaron® or like material, also provides a housing which is thermally stable and resistant to chemical attack, and which is thus suited to the harsh environment of an oil and gas installation.

The inner housing may comprise and/or may be at least partially constructed from a meta-aramid material.

The inner housing may comprise and/or may be at least partially constructed from Nomex® or like material.

Beneficially, an inner housing constructed from a meta-aramid material, such as Nomex® or like material, provides a barrier capable of containing one or more components of the actuator ejected in the event of actuator failure. An inner housing constructed from a meta-aramid material, such as Nomex® or like material, also provides a housing which is fire resistant, and which is thus suited to the harsh environment of an oil and gas installation.

The inner housing may comprise and/or may be at least partially constructed from a composite material, such as glass fibre composite or carbon fibre composite; and/or a polymeric material, such as Polyether Ether Ketone (PEEK).

Beneficially, an inner housing constructed from a composite material, such as glass fibre composite or carbon fibre composite; and/or a polymeric material, such as Polyether Ether Ketone (PEEK) may provide a rigid inner housing.

The inner housing may comprise a unitary construction. For example, the inner housing may be constructed as a moulded component or a continuously wound component.

Alternatively, the inner housing may comprise a modular construction.

The inner housing may comprise a plurality of layers of material, such as the materials described above.

Where the safety apparatus comprises a plurality of the outer housings, the safety apparatus may comprise a plurality of the inner housings.

For example, the safety apparatus may comprise a first inner housing for location within the first outer housing and a second inner housing for location in the second outer housing.

The safety apparatus may comprise an indicator arrangement.

The indicator arrangement may form part of the housing arrangement.

The indicator arrangement may be configured to provide an indication that failure of the actuator has occurred.

The indicator arrangement may be interposed between the inner housing and the outer housing, for example in the cavity between the inner housing and the outer housing.

The indicator arrangement may be configured for location around the inner housing.

The indicator arrangement may be configured for location within the outer housing.

The indicator arrangement may comprise a visual indicator, such as a dye.

The visual indicator, e.g. dye, may be contained within an indicator housing.

Beneficially, the provision of an indicator housing permits the visual indicator to be securely stored.

The indicator housing may comprise or take the form of a bag.

Alternatively, the indicator housing may comprise or take the form of a sponge, a gel or other material suitable for storing the visual indicator.

The indicator housing may be configured to release the dye in the event of failure of the actuator.

The indicator housing may be configured to puncture or otherwise release the visual indicator when subjected to a force reaching a selected threshold force.

The selected threshold force may be selected to be of a magnitude greater than that experienced by the safety apparatus in normal operation. This ensures that the indicator arrangement does not prematurely activate, for example due to expansion and compression resulting from fluctuations in temperature or other environmental forces on the safety apparatus and/or an external impact on the safety apparatus.

The selected threshold force may be of a magnitude greater than or equal to an impact force on the inner housing resulting from ejection of the one or more component of the actuator during failure and/or resulting from the direct impact of the ejected component on the indicator housing itself.

In use, release of the visual indicator may be determined externally of the actuator, for example by personnel or by remote monitoring system, such as CCTV.

The outer housing may be configured to absorb the visual indicator, such that the visual indicator bleeds through to an external surface of the outer housing.

Alternatively or additionally, the outer housing may comprise a weep hole to permit the visual indicator to pass to an exterior of the safety apparatus.

The indicator housing may comprise a base portion.

The indicator housing may comprise a wall portion.

The wall portion of the indicator housing may extend from the base portion.

The indicator housing may comprise a unitary component. For example, the indicator housing may define a single envelope for receiving the visual indicator.

Alternatively, the indicator housing may comprise a plurality of housing portions. The indicator housing may, for example, comprise a first housing portion for containing a first visual indicator and a second housing portion for containing a second visual indicator. The second visual indicator may be different to the first visual indicator. For example, the second visual indicator may be a different colour to the first visual indicator.

Beneficially, the use of different visual indicators may permit an operator to determine the likely cause of the actuator failure from the colour of the visual indicator.

Where the safety apparatus comprises a plurality of the outer housings, the indicator arrangement may comprise a plurality of the indicator housings. For example, the safety apparatus may comprise a first indicator housing for location between the first outer housing and the first inner housing and a second indicator housing for location between the second outer housing and the second inner housing.

The indicator arrangement may comprise a label indicating that failure has occurred.

The indicator arrangement may comprise a status indicator.

The status indicator may be reconfigurable from a first configuration to a second configuration. The status indicator in the second configuration indicating that failure of the actuator has occurred.

The status indicator may comprise an indicator strip or streamer. The indicator strip may be coloured, e.g. red, to as to indicate the status of the safety apparatus.

The status indicator may be configured such the indicator strip is covered in the first configuration, reconfiguration of the status indicator from the first configuration to the second configuration uncovering the indicator strip.

The status indicator may be reconfigurable from the first configuration to the second configuration in response to force exceeding a threshold force, for example the selected threshold force at which the indicator housing is configured to puncture or otherwise release the visual indicator. The threshold force may comprise an axial force applied to the status indicator.

The status indicator may, for example, comprise and/or take the form of a piece of material. The piece of material may comprise portions folded, sewn or otherwise arranged to cover the indicator strip in the first configuration.

Alternatively or additionally, the status indicator may be deformable member reconfigurable from the first configuration to the second configuration.

The status indicator may be provided in combination with the label to indicate the status of the safety apparatus.

The safety apparatus may comprise a securement arrangement.

The securement arrangement may be configured to retain the housing arrangement on the actuator.

The securement arrangement may be configured for location around the housing arrangement, in particular around the outer housing.

The securement arrangement may comprise at least one strap.

The securement arrangement may comprise a plurality of straps.

The strap, or at least one of the straps, may comprise and/or may be at least partially constructed from a synthetic fibre material.

The strap, or at least one of the straps, may comprise and/or may be at least partially constructed from a polyethylene material or like material, for example an Ultra-High Molecular Weight Polyethylene (UHMwPE), such as Dyneema® or like material.

Alternatively or additionally, the strap, or at least one of the straps, may comprise and/or may be at least partially constructed from polyester or like material.

Alternatively or additionally, the strap, or at least one of the straps, may comprise and/or may be at least partially constructed from an aramid material, for example:

a para-aramid material such as Kevlar®, Twaron® or like material; and/or

a meta-aramid material, such as Nomex® or like material.

The label may be provided on the securement arrangement of the safety apparatus. For example, the label may be provided on one or more strap of the securement arrangement.

The status indicator may be provided on the securement arrangement of the safety apparatus. For example, the status indicator may be provided on one or more strap of the securement arrangement.

The securement arrangement may be coupled to the outer housing.

The securement arrangement may further comprise one or more guide.

The guides may be disposed at the interfaces between the straps to assist in installation and to ensure that the straps remain in position once installed.

The securement arrangement may further comprise one or more profiled edge piece.

The edge pieces may be provided on the outer housing, the edge pieces disposed at the interface between the base portion and the wall portion of the outer housing.

Beneficially, the edge pieces guide the straps around the interface between the base portion and the wall portion of the outer housing while avoiding sharp edges.

The securement arrangement may comprise a fastener for securing the strap.

The fastener may comprise a ratchet fastener.

Where the safety apparatus comprises a plurality of outer housings, the securement arrangement may be disposed about both the first outer housing and the second outer housing and configured to secure the first outer housing the second outer housing together.

Beneficially, by virtue of its location on the first end portion of the actuator the first outer housing may assist in retaining the second outer housing in the event of failure of the actuator, and vice-versa.

The safety apparatus may comprise one or more protective layer.

The protective layer, or where the apparatus comprises a plurality of protective layers at least one of the layers, may comprise a nylon material or like material.

The protective layer, or where the apparatus comprises a plurality of protective layers at least one of the protective layers, may comprise a waterproof layer.

Alternatively or additionally, the protective layer, or where the apparatus comprises a plurality of protective layers at least one of the protective layers may provide protection against UV degradation.

One or more protective layer may be disposed in, on and/or around the outer housing.

For example, one or more protective layer may be disposed on an exterior of the outer housing. The protective layer disposed on an exterior of the outer housing may comprise and/or may be at least partially constructed from a nylon woven material coated in polyurethane, or like material.

Alternatively or additionally, one or more protective layer may be disposed on an interior of the outer housing, such as between the inner housing and the outer housing.

The protective layer disposed on an exterior of the outer housing may comprise and/or may be at least partially constructed from a PVC material or like material At least one protective layer may comprise a base portion and a wall portion, the wall portion extending from the base portion.

The safety apparatus may be provided in combination with the actuator.

According to a second aspect, there is provided an actuator assembly comprising:

the safety apparatus of the first aspect; and

an actuator.

According to a third aspect, there is provided a kit of parts comprising:

an outer housing comprising a base portion and a wall portion extending from the base portion;

an inner housing; and

an indicator arrangement,

the outer housing, the inner housing and the indicator arrangement forming or forming part of a housing arrangement configured for location on an actuator, the housing arrangement defining an enclosure for encompassing an end portion of the actuator and configured to form a barrier for containing one or more component of the actuator in the event of actuator failure.

The kit may comprise a plurality of the outer housings. For example, the kit may comprise a first outer housing for location about a first end portion of the actuator and a second outer housing for location about a second end portion of the actuator.

In such embodiments, the securement arrangement may be disposed about both the first outer housing and the second outer housing and configured to secure the first outer housing the second outer housing together.

Where the kit comprises a plurality of the outer housings, the safety apparatus may further comprise a plurality of the inner housings. For example, the kit may comprise a first inner housing for location within the first outer housing and a second inner housing for location in the second outer housing.

Where the kit comprises a plurality of the outer housings, the indicator arrangement may comprise a plurality of the indicator housings. For example, the kit may comprise a first indicator housing for location between the first outer housing and the first inner housing and a second indicator housing for location between the second outer housing and the second inner housing.

A fourth aspect relates to use of the safety apparatus according to the first aspect to resist ejection of one or more component of the actuator in the event of actuator failure.

The features defined above or below may be utilised, either alone or in combination with any other defined feature.

### BRIEF DESCRIPTION OF THE DRAWINGS

FIG. 1 shows a perspective view of a safety apparatus;

FIG. 2 shows a part cutaway view of the safety apparatus shown in FIG. 1;

FIG. 3 shows an enlarged sectional view showing a housing arrangement of the safety apparatus shown in FIG. 1;

FIG. 4 shows an enlarged sectional view of a second housing arrangement of the safety apparatus shown in FIG. 1;

FIG. 5 shows an enlarged bottom view of part of the housing arrangement shown in FIG. 3;

FIG. 6 shows an enlarged bottom view of part of the second housing arrangement shown in FIG. 4;

FIG. 7 shows an enlarged view of a status indicator of the safety apparatus shown in FIG. 1, in a first configuration;

FIG. 8 shows an enlarged view of the status indicator shown in FIG. 7, in a second configuration;

FIG. 9 show an enlarged view of part of a securement arrangement of the safety apparatus shown in FIG. 1;

FIG. 10 shows an enlarged view of another part of the securement arrangement of the safety apparatus shown in FIG. 1;

FIG. 11 shows an enlarged view of another part of the securement arrangement of the safety apparatus shown in FIG. 1;

FIG. 12 shows an enlarged view of another part of the securement arrangement of the safety apparatus shown in FIG. 1;

FIG. 13 shows a perspective view of an alternative safety apparatus;

FIG. 14 shows a part cutaway view of the safety apparatus shown in FIG. 13;

FIG. 15 shows an enlarged sectional view showing a housing arrangement of the safety apparatus shown in FIG. 13;

FIG. 16 shows an enlarged sectional view of a second housing arrangement of the safety apparatus shown in FIG. 13;

FIG. 17 shows an enlarged bottom view of part of the housing arrangement shown in FIG. 15;

FIG. 18 shows an enlarged bottom view of part of the second housing arrangement shown in FIG. 16;

FIG. 19 shows an enlarged view of a status indicator of the safety apparatus shown in FIG. 13, in a first configuration;

FIG. 20 shows an enlarged view of the status indicator shown in FIG. 19, in a second configuration;

FIG. 21 show an enlarged view of part of a securement arrangement of the safety apparatus shown in FIG. 13;

FIG. 22 shows an enlarged view of another part of the securement arrangement of the safety apparatus shown in FIG. 13;

FIG. 23 shows an enlarged view of another part of the securement arrangement of the safety apparatus shown in FIG. 13;

FIG. 24 shows an enlarged view of another part of the securement arrangement of the safety apparatus shown in FIG. 13;

FIG. 25 shows a perspective part cutaway view of a further alternative safety apparatus;

FIG. 26 shows an enlarged sectional view of a housing arrangement of the safety apparatus shown in FIG. 25;

FIG. 27 show an enlarged view of part of a securement arrangement of the safety apparatus shown in FIG. 13;

FIG. 28 shows an enlarged view of another part of the securement arrangement of the safety apparatus shown in FIG. 25;

FIG. 29 shows an enlarged view of another part of the securement arrangement of the safety apparatus shown in FIG. 25; and

FIG. 30 shows an enlarged view of another part of the securement arrangement of the safety apparatus shown in FIG. 25.

### DETAILED DESCRIPTION OF THE DRAWINGS

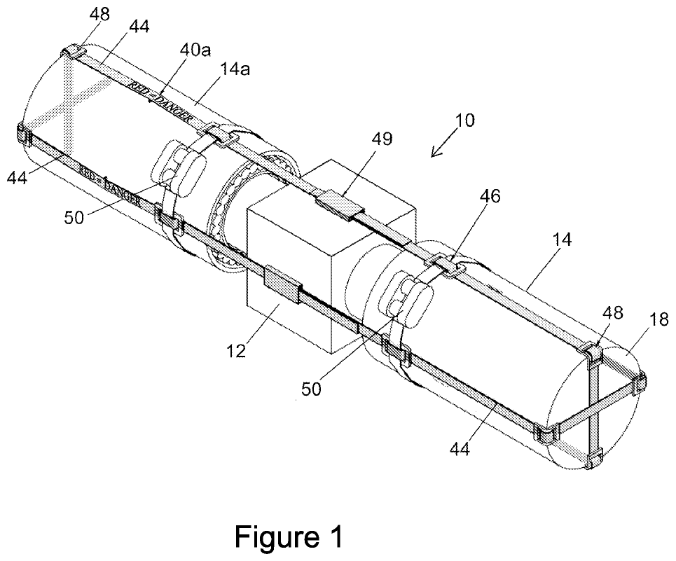

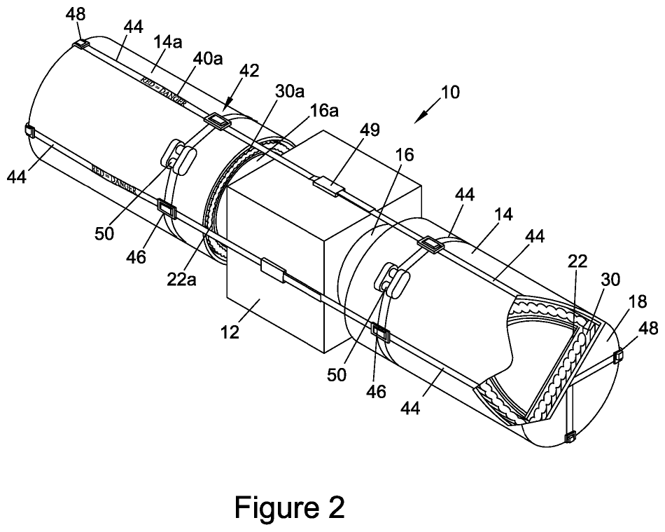

FIGS. 1 and 2 of the accompanying drawings shows a perspective view of a safety apparatus 10 for an actuator 12.

In use, the safety apparatus 10 is locatable on the actuator 12 and is configured to form a barrier for containing one or more component of the actuator 12 ejected in the event of actuator failure.

The safety apparatus 10 has a housing arrangement including an outer housing 14, the outer housing 14 encompassing an end portion 16 of the actuator 12.

In the illustrated safety apparatus 10 shown in FIGS. 1 and 2, the outer housing 14 takes the form of a para-aramid bag, the para-aramid construction beneficially resulting in an outer housing 14 capable of containing the energy of the ejected components and other contained energy, reducing the risk to personnel and other equipment.

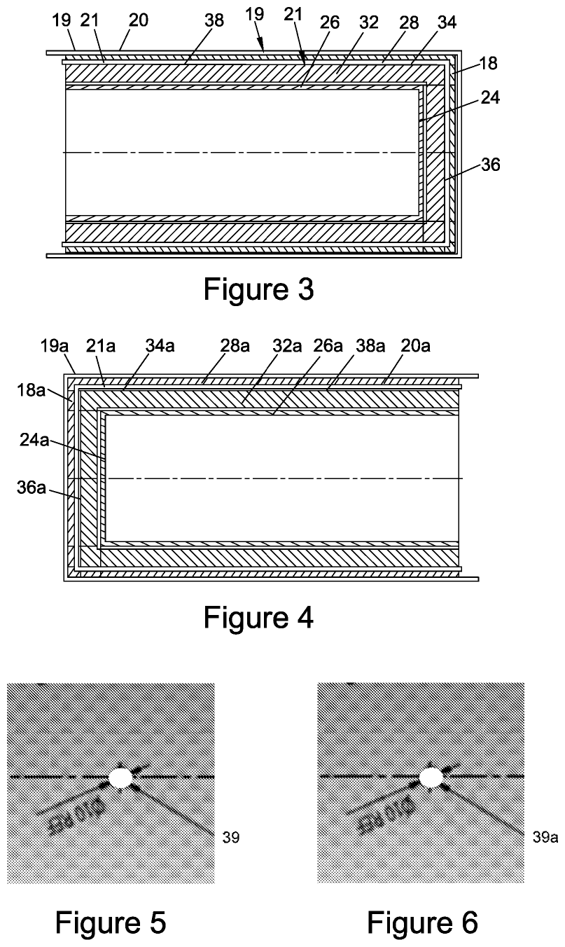

As shown in FIG. 3, the outer housing 14 has a solid base portion 18 and a wall portion 20 extending from the base portion 18, the base portion 18 and the wall portion 20 defining an enclosure for encompassing the end portion 16 of the actuator 12. Beneficially, the base portion 18 and the wall portion 20 form an outer housing 14 which is capable of containing components ejected both axially and laterally from the actuator 12 in the event of failure. As shown, the outer housing 14 is generally cylindrical in shape. However, it will be recognised that the outer housing 14 may define any suitable shape.

A protective layer 19 is disposed on an exterior of the outer housing 14. The protective layer 19 is formed from a nylon woven material coated in polyurethane. The protective layer 19 is generally cylindrical in shape. However, it will be recognised that the protective layer 19 may define any suitable shape.

A further protective layer 21 is disposed on an interior of the outer housing 14. The protective layer 21 is formed from PVC. The protective layer 21 is generally cylindrical in shape. However, it will be recognised that the protective layer 21 may define any suitable shape.

The housing arrangement of the safety apparatus 10 further comprises an inner housing 22. In use, the inner housing 22 defines an armour layer of the safety apparatus 10. The inner housing 22 is disposed within the outer housing 14 and is configured for location about the end portion 16 of the actuator 12.

In the illustrated safety apparatus 10, the inner housing 22 takes the form of a para-aramid bag, the para-aramid construction beneficially resulting in an inner housing 22 capable of containing the energy of the ejected components, reducing the risk to personnel and other equipment.

As shown in FIG. 3, the inner housing 22 has a solid base portion 24 and a wall portion 26 extending from the base portion 24. Beneficially, the provision of outer housing 14 and inner housing 22 provides additional resistance to ejection of components of the actuator 12 in the event of failure.

The inner housing 22 is offset from the outer housing 14, such that the inner housing 22 and the outer housing 14 together define a cavity 28 for receiving an indicator arrangement 30, the indicator arrangement 30 forming part of the housing arrangement of the safety apparatus 10.

The indicator arrangement 30 is configured to provide a visual indication that failure of the actuator 12 has occurred, and comprises a visual indicator in the form of a coloured dye 32. In the illustrated safety apparatus 10, the dye 32 is a red in colour. However, it will be recognised that the dye 32 may be any suitable colour.

As shown in FIG. 3, the dye 32 is contained within an indicator housing 34, the indicator housing 34 configured to puncture or otherwise release the dye 32 to indicate when failure of the actuator 12 has occurred. Release of the dye 32 may be determined externally of the actuator 12, for example by personnel or by remote monitoring system, such as a CCTV system. The indicator housing 34 is interposed between the inner housing 22 and the outer housing 14, and comprises a solid base portion 36 and a wall portion 38 extending from the base portion 36, the base portion 36 and wall portion 38 defining a cavity for receiving the dye 32.

As shown in FIGS. 1 and 2, and referring also to FIG. 4 of the accompanying drawings, the safety apparatus 10 further comprises a second outer housing 14a, the outer housing 14a encompassing an end portion 16a of the actuator 12.

As shown in FIG. 4, the outer housing 14a is substantially identical to the outer housing 14, having a solid base portion 18a and a wall portion 20a extending from the base portion 18a, the base portion 18a and the wall portion 20a defining an enclosure for encompassing the end portion 16a of the actuator 12. The base portion 18a and the wall portion 20a form an outer housing 14a which is capable of containing components ejected both axially and laterally from the actuator 12 in the event of failure. The outer housing 14a is generally cylindrical in shape. However, it will be recognised that the outer housing 14a may define any suitable shape.

The outer housing 14a takes the form of a para-aramid bag, the para-aramid construction beneficially resulting in an outer housing 14a capable of containing the energy of the ejected components, and reducing the risk to personnel and other equipment.

The safety apparatus 10 further comprises an inner housing 22a, the inner housing 22a disposed within the outer housing 14a and configured for location about the end portion 16a of the actuator 12. In use, the inner housing 22a defines an armour layer of the safety apparatus 10.

As shown in FIG. 4, the inner housing 22a has a solid base portion 24a and a wall portion 26a extending from the base portion 24a. Beneficially, the provision of outer housing 14a and inner housing 22a provides additional resistance to ejection of components of the actuator 12 in the event of failure.

A protective layer 19a is disposed on an exterior of the outer housing 14a. The protective layer 19a is formed from a nylon woven material coated in polyurethane. The protective layer 19a is generally cylindrical in shape. However, it will be recognised that the protective layer 19a may define any suitable shape.

A further protective layer 21a is disposed on an interior of the outer housing 14a. The protective layer 21a is formed from PVC. The protective layer 21a is generally cylindrical in shape. However, it will be recognised that the protective layer 21a may define any suitable shape.

The inner housing 22a takes the form of a para-aramid bag, the para-aramid construction beneficially resulting in an inner housing 22a capable of containing the energy of the ejected components, and reducing the risk to personnel and other equipment.

The inner housing 22a is offset from the outer housing 14a, such that the inner housing 22a and the outer housing 14a together define a cavity 28a for receiving an indicator arrangement 30a.

The indicator arrangement 30a is configured to provide a visual indication that failure of the actuator 12 has occurred, and comprises a visual indicator in the form of a coloured dye 32a. In the illustrated safety apparatus 10, the dye 32a is a red in colour. However, it will be recognised that the dye 32a may be any suitable colour.

As shown in FIG. 4, the dye 32a is contained within an indicator housing 34a, the indicator housing 34a configured to puncture or otherwise release the dye 32a to indicate when failure of the actuator 12 has occurred. Release of the dye 32a may be determined externally of the actuator 12, for example by personnel or by remote monitoring system, such as a CCTV system. The indicator housing 34a is interposed between the inner housing 22a and the outer housing 14a, and comprises a solid base portion 36a and a wall portion 38a extending from the base portion 36a, the base portion 36a and wall portion 38a defining a cavity for receiving the dye 32a.

As shown in FIGS. 5 and 6, in the safety apparatus 10 the outer housings 14,14a each comprise a weep hole 39,39a for permitting the dye 32,32a to escape, and thus indicate that the actuator 12 has failed. However, it will be recognised that in other arrangements the safety apparatus may not have a weep hole 39,39a.

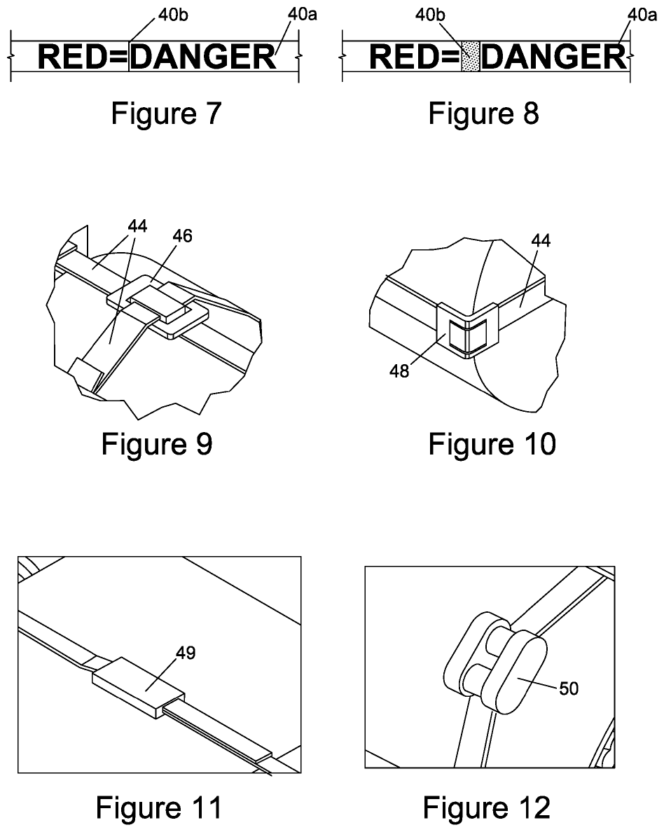

As shown in FIG. 1 and referring now also to FIGS. 7 and 8 of the accompanying drawings, the indicator arrangement 30a further comprises a label 40a and a safety indicator in the form of indicator strip 40b. The indicator strip 40b comprises a piece of material which is folded and/or sown together to form a seam. In use, when exposed to an axial load the seam bursts, thereby exposing the indicator strip 40b.

As shown in FIGS. 1 and 2, the safety apparatus 10 has a securement arrangement—shown generally by 42—configured to retain the outer housings 14,14a on the actuator 12.

The securement arrangement 42 is configured for location around the housings 14,14a and comprises a plurality of straps 44. In the safety apparatus 10, the straps 44 are constructed from an Ultra-High Molecular Weight Polyethylene (UHMwPE), material, e.g. Dyneema®.

Referring now also to FIGS. 9, 10, 11 and 12 of the accompanying drawings, there are shown enlarged views of parts of the safety apparatus 10.

As shown in FIG. 9, the securement arrangement 42 further comprises guides 46, the guides 46 provided on the housings 14,14a, respectively. The guides 46 are disposed at the interfaces between the straps 44 to assist in installation and to ensure that the straps 44 remain in position once installed.

As shown in FIG. 10, the securement arrangement 42 further comprises profiled edge pieces 48, the edge pieces 48 provided on the housing 14,14a, respectively. The edge pieces 48 are disposed at the interface between the base portion 18 and the wall portion 20 and at the interface between the base portion 18a and the wall portion 20a. The edge pieces 48 guide the straps 44 around the interface between the base portions 18,18a and the wall portions 20,20a while avoiding sharp edges.

As shown in FIG. 11, the securement arrangement 42 further comprises buckles 49.

As shown in FIG. 12, the securement arrangement 42 further comprises fasteners 50, the fasteners 50 in the safety apparatus 10 comprising ratchet fasteners, buckle or similar appropriate joining arrangement.

The safety apparatus 10 provide a number of benefits. For example, the safety apparatus 10 is passive, that is the safety apparatus 10 has no actuation mechanism and/or does not require power to operate. Beneficially, the provision of a passive safety apparatus eliminates or at least reduces the risk posed by the release of stored energy and/or ejection of components resulting from failure on all actuators, including those which are not subject to regular inspection and/or which are located on oil and gas installations which are in the process of being decommissioned and for which repair and replacement of the actuator is impractical or uneconomical.

It will be recognised that the safety apparatus described above is merely exemplary and that various modifications may be made.

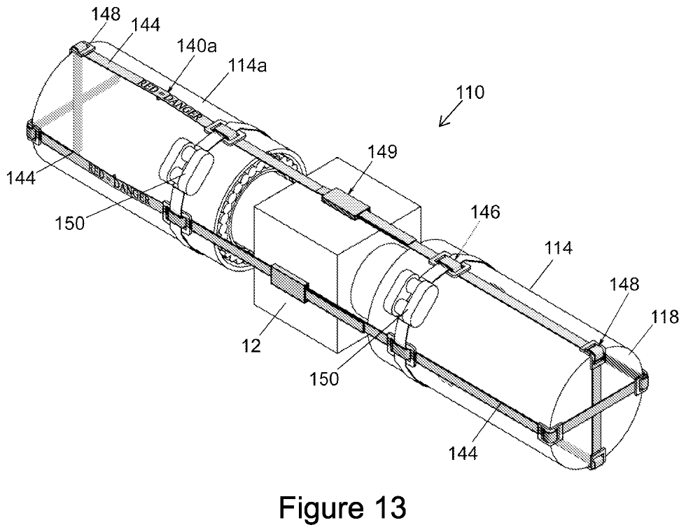

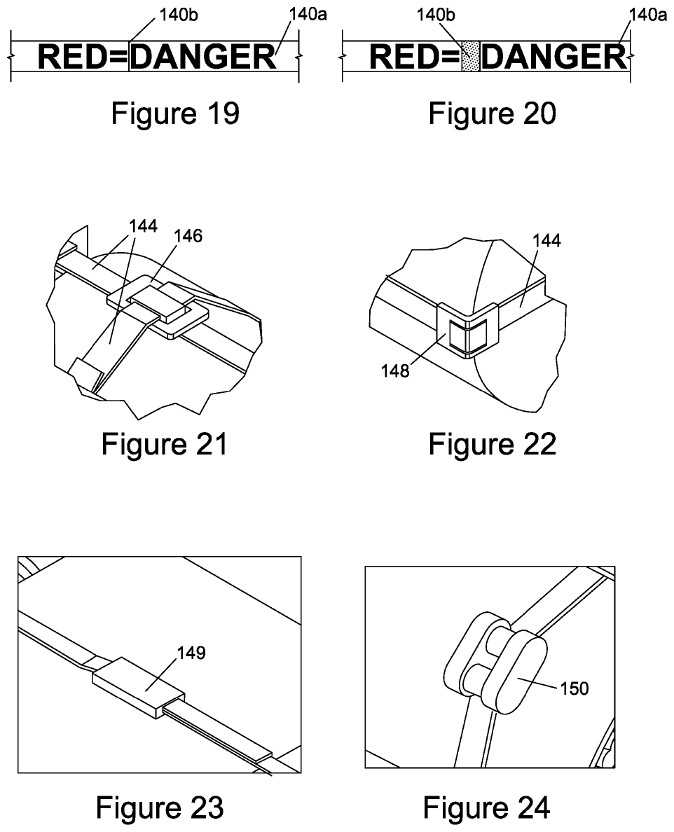

For example, reference is now made to FIGS. 13 to 24 of the accompanying drawings which shows an alternative safety apparatus 110. The safety apparatus 110 is similar to the safety apparatus 10 and like components are represented by like numerals incremented by 100. However, whereas in the safety apparatus 10 the outer housings 14,14a are constructed from a para-aramid material, in the safety apparatus 110 the outer housings 114,114a are constructed from a meta-aramid material.

In the illustrated safety apparatus 110 shown in FIGS. 13 to 24, the housing arrangement includes an outer housing 114 which takes the form of a meta-aramid bag, the meta-aramid construction resulting in an outer housing 114 capable of containing the energy of the ejected components and other contained energy, reducing the risk to personnel and other equipment. Moreover, the meta-aramid construction results in an outer housing 114 which is fire resistant, and thus suited to the harsh environment of an oil and gas installation.

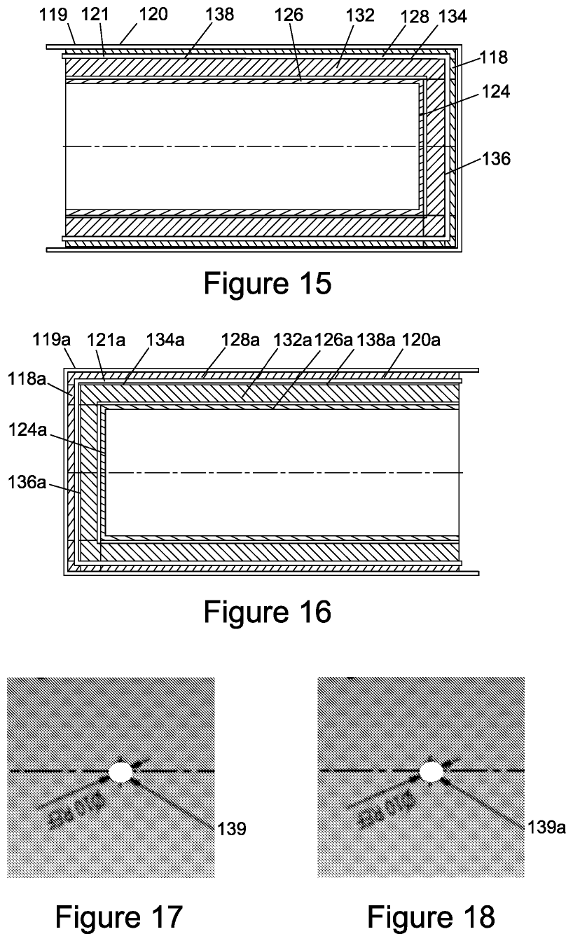

As shown in FIG. 15, the outer housing 114 has a solid base portion 118 and a wall portion 120 extending from the base portion 118, the base portion 18 and the wall portion 120 defining an enclosure for encompassing the end portion 16 of the actuator 12. Beneficially, the base portion 118 and the wall portion 120 form an outer housing 114 which is capable of containing components ejected both axially and laterally from the actuator 12 in the event of failure. As shown, the outer housing 114 is generally cylindrical in shape. However, it will be recognised that the outer housing 14 may define any suitable shape.

A protective layer 119 is disposed on an exterior of the outer housing 114. The protective layer 119 is formed from a nylon woven material coated in polyurethane. The protective layer 119 is generally cylindrical in shape. However, it will be recognised that the protective layer 119 may define any suitable shape.

A further protective layer 121 is disposed on an interior of the outer housing 114. The protective layer 121 is formed from PVC. The protective layer 121 is generally cylindrical in shape. However, it will be recognised that the protective layer 121 may define any suitable shape.

The safety apparatus 110 further comprises an inner housing 122. In use, the inner housing 122 defines an armour layer of the safety apparatus 110. The inner housing 122 is disposed within the outer housing 114 and is configured for location about the end portion 16 of the actuator 12.

In the illustrated safety apparatus 110, the inner housing 122 takes the form of a para-aramid bag, the para-aramid construction beneficially resulting in an inner housing 122 capable of containing the energy of the ejected components, reducing the risk to personnel and other equipment.

As shown in FIG. 15, the inner housing 122 has a solid base portion 124 and a wall portion 126 extending from the base portion 124. Beneficially, the provision of outer housing 114 and inner housing 122 provides additional resistance to ejection of components of the actuator 12 in the event of failure.

The inner housing 122 is offset from the outer housing 114, such that the inner housing 122 and the outer housing 114 together define a cavity 128 for receiving an indicator arrangement 130 of the safety apparatus 110.

The indicator arrangement 130 is configured to provide a visual indication that failure of the actuator 12 has occurred, and comprises a visual indicator in the form of a coloured dye 132. In the illustrated safety apparatus 110, the dye 132 is a red in colour. However, it will be recognised that the dye 132 may be any suitable colour.

As shown in FIG. 15, the dye 132 is contained within an indicator housing 134, the indicator housing 134 configured to puncture or otherwise release the dye 132 to indicate when failure of the actuator 12 has occurred. Release of the dye 132 may be determined externally of the actuator 12, for example by personnel or by remote monitoring system, such as a CCTV system. The indicator housing 134 is interposed between the inner housing 122 and the outer housing 114, and comprises a solid base portion 136 and a wall portion 138 extending from the base portion 136, the base portion 136 and wall portion 138 defining a cavity for receiving the dye 132.

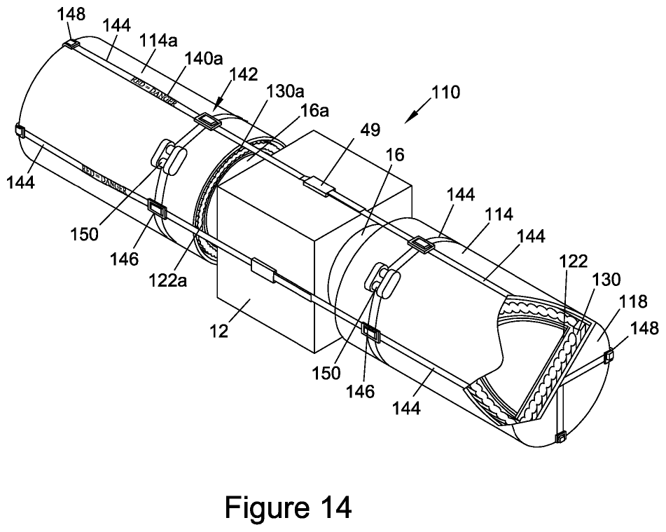

As shown in FIGS. 13 and 14, and referring also to FIG. 16 of the accompanying drawings, the safety apparatus 110 further comprises a second outer housing 114a, the outer housing 114a encompassing an end portion 16a of the actuator 12.

As shown in FIG. 16, the outer housing 114a is substantially identical to the outer housing 114, having a solid base portion 118a and a wall portion 120a extending from the base portion 118a, the base portion 118a and the wall portion 120a defining an enclosure for encompassing the end portion 16a of the actuator 12. The base portion 118a and the wall portion 120a form an outer housing 114a which is capable of containing components ejected both axially and laterally from the actuator 12 in the event of failure. The outer housing 114a is generally cylindrical in shape. However, it will be recognised that the outer housing 114a may define any suitable shape.

The outer housing 114a takes the form of a meta-aramid bag, the meta-aramid construction resulting in an outer housing 114a capable of containing the energy of the ejected components, reducing the risk to personnel and other equipment. The meta-aramid construction also results in an outer housing 114a which is fire resistant, and which is thus suited to the harsh environment of an oil and gas installation.

A protective layer 119a is disposed on an exterior of the outer housing 114a. The protective layer 119a is formed from a nylon woven material coated in polyurethane. The protective layer 119a is generally cylindrical in shape. However, it will be recognised that the protective layer 119a may define any suitable shape.

A further protective layer 121a is disposed on an interior of the outer housing 114a. The protective layer 121a is formed from PVC. The protective layer 121a is generally cylindrical in shape. However, it will be recognised that the protective layer 121a may define any suitable shape.

The safety apparatus 10 further comprises an inner housing 122a, the inner housing 122a disposed within the outer housing 114a and configured for location about the end portion 16a of the actuator 12. In use, the inner housing 122a defines an armour layer of the safety apparatus 10.

As shown in FIG. 16, the inner housing 122a has a solid base portion 124a and a wall portion 126a extending from the base portion 124a. Beneficially, the provision of outer housing 114a and inner housing 122a provides additional resistance to ejection of components of the actuator 12 in the event of failure.

The inner housing 122a takes the form of a para-aramid bag, the para-aramid construction beneficially resulting in an inner housing 122a capable of containing the energy of the ejected components, and reducing the risk to personnel and other equipment.

The inner housing 122a is offset from the outer housing 114a, such that the inner housing 122a and the outer housing 114a together define a cavity 128a for receiving an indicator arrangement 130a.

The indicator arrangement 130a is configured to provide a visual indication that failure of the actuator 12 has occurred, and comprises a visual indicator in the form of a coloured dye 132a. In the illustrated safety apparatus 110, the dye 132a is a red in colour. However, it will be recognised that the dye 132a may be any suitable colour.

As shown in FIG. 16, the dye 132a is contained within an indicator housing 134a, the indicator housing 134a configured to puncture or otherwise release the dye 132a to indicate when failure of the actuator 12 has occurred. Release of the dye 132a may be determined externally of the actuator 12, for example by personnel or by remote monitoring system, such as a CCTV system. The indicator housing 134a is interposed between the inner housing 122a and the outer housing 114a, and comprises a solid base portion 136a and a wall portion 138a extending from the base portion 136a, the base portion 136a and wall portion 138a defining a cavity for receiving the dye 132a.

As shown in FIGS. 17 and 18, in the safety apparatus 110 the outer housings 114,114a each comprise a weep hole 139,139a for permitting the dye 132,132a to escape, and thus indicate that the actuator 12 has failed.

As shown in FIGS. 13 and 14 and referring now also to FIGS. 15 and 16 of the accompanying drawings, the indicator arrangement 130a further comprises a label 140a and a safety indicator in the form of indicator strip 140b. The indicator strip 140b comprises a piece of material which is folded and/or sown together to form a seam. In use, when exposed to an axial load the seam bursts, thereby exposing the indicator strip 140b.

As shown in FIGS. 13 and 14, the safety apparatus 110 has a securement arrangement—shown generally by 142—configured to retain the outer housings 114,114a on the actuator 12.

The securement arrangement 142 is configured for location around the housings 114,114a and comprises a plurality of straps 144. In the safety apparatus 110, the straps 144 are constructed from an Ultra-High Molecular Weight Polyethylene (UHMwPE), e.g. Dyneema®.

Referring now also to FIGS. 21, 22, 23 and 24 of the accompanying drawings, there are shown enlarged views of parts of the securement arrangement 142.

As shown in FIG. 21, the securement arrangement 142 further comprises guides 146, the guides 146 provided on the housings 114,114a, respectively. The guides 146 are disposed at the interfaces between the straps 144 to assist in installation and to ensure that the straps 144 remain in position once installed.

As shown in FIG. 22, the securement arrangement 142 further comprises profiled edge pieces 148, the edge pieces 148 provided on the housing 114,114a, respectively. The edge pieces 148 are disposed at the interface between the base portion 118 and the wall portion 120 and at the interface between the base portion 118a and the wall portion 120a. The edge pieces 48 guide the straps 144 around the interface between the base portions 118,118a and the wall portion 120,120a while avoiding sharp edges.

As shown in FIG. 23, the securement arrangement 42 further comprises buckles 49.

As shown in FIG. 24, the securement arrangement 142 further comprises fasteners 150, the fasteners 150 in the safety apparatus 10 comprising ratchet fasteners, buckle or similar appropriate joining arrangement.

As described above, the safety apparatus 10,110 are merely exemplary and various modifications may be made.

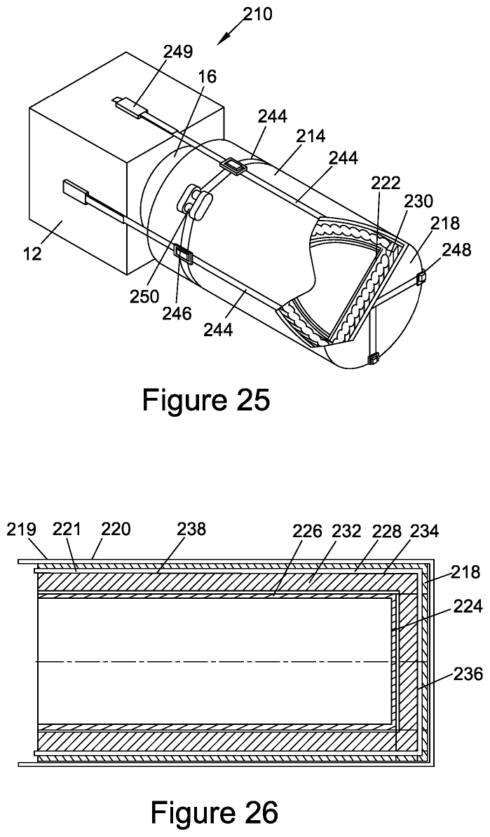

For example, reference is now made to FIG. 25 of the accompanying drawings which shows a further alternative safety apparatus 210. The safety apparatus 210 is similar to the safety apparatus 10 and like components are represented by like numerals incremented by 200. However, whereas the safety apparatus 10 comprises two outer housings 14,14a, in the safety apparatus 210 a single outer housing 214 is provided.

The safety apparatus 210 has a housing arrangement including an outer housing 214, the outer housing 214 encompassing an end portion 16 of the actuator 12.

In the illustrated safety apparatus 210 shown in FIGS. 25 to 30, the outer housing 214 takes the form of a para-aramid bag, the para-aramid construction beneficially resulting in an outer housing 214 capable of containing the energy of the ejected components and other contained energy, reducing the risk to personnel and other equipment.

As shown in FIG. 26, the outer housing 214 has a solid base portion 218 and a wall portion 220 extending from the base portion 218, the base portion 218 and the wall portion 220 defining an enclosure for encompassing the end portion 16 of the actuator 12. Beneficially, the base portion 218 and the wall portion 220 form an outer housing 214 which is capable of containing components ejected both axially and laterally from the actuator 12 in the event of failure. As shown, the outer housing 214 is generally cylindrical in shape. However, it will be recognised that the outer housing 214 may define any suitable shape.

A protective layer 219 is disposed on an exterior of the outer housing 214. The protective layer 219 is formed from a nylon woven material coated in polyurethane. The protective layer 219 is generally cylindrical in shape. However, it will be recognised that the protective layer 219 may define any suitable shape.

A further protective layer 221 is disposed on an interior of the outer housing 214. The protective layer 221 is formed from PVC. The protective layer 221 is generally cylindrical in shape. However, it will be recognised that the protective layer 221 may define any suitable shape.

The housing arrangement of the safety apparatus 210 further comprises an inner housing 222. In use, the inner housing 222 defines an armour layer of the safety apparatus 210. The inner housing 222 is disposed within the outer housing 214 and is configured for location about the end portion 16 of the actuator 12.

In the illustrated safety apparatus 210, the inner housing 222 takes the form of a para-aramid bag, the para-aramid construction beneficially resulting in an inner housing 222 capable of containing the energy of the ejected components, reducing the risk to personnel and other equipment.

As shown in FIG. 26, the inner housing 222 has a solid base portion 224 and a wall portion 226 extending from the base portion 224. Beneficially, the provision of outer housing 214 and inner housing 222 provides additional resistance to ejection of components of the actuator 12 in the event of failure.

The inner housing 222 is offset from the outer housing 214, such that the inner housing 222 and the outer housing 214 together define a cavity 228 for receiving an indicator arrangement 230, the indicator arrangement 230 forming part of the housing arrangement of the safety apparatus 210.

The indicator arrangement 230 is configured to provide a visual indication that failure of the actuator 12 has occurred, and comprises a visual indicator in the form of a coloured dye 232. In the illustrated safety apparatus 210, the dye 232 is a red in colour. However, it will be recognised that the dye 232 may be any suitable colour.

As shown in FIG. 26, the dye 232 is contained within an indicator housing 234, the indicator housing 234 configured to puncture or otherwise release the dye 232 to indicate when failure of the actuator 12 has occurred. Release of the dye 232 may be determined externally of the actuator 12, for example by personnel or by remote monitoring system, such as a CCTV system. The indicator housing 234 is interposed between the inner housing 222 and the outer housing 214, and comprises a solid base portion 236 and a wall portion 238 extending from the base portion 236, the base portion 236 and wall portion 238 defining a cavity for receiving the dye 232.

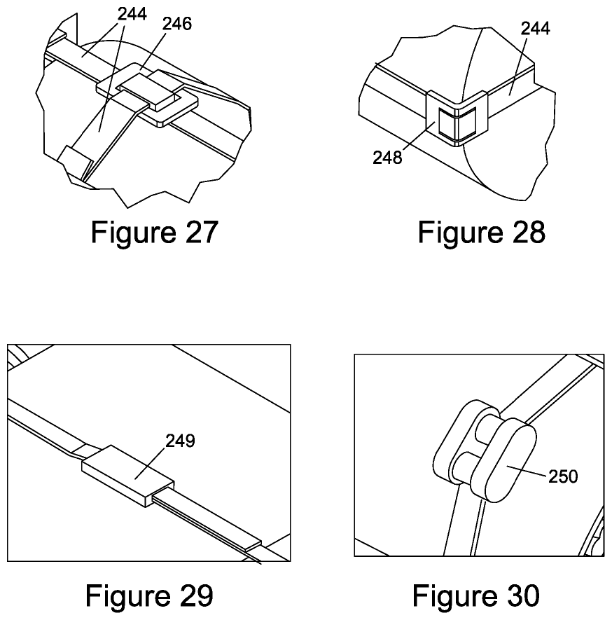

Referring now also to FIGS. 27, 28, 29 and 30 of the accompanying drawings, there are shown enlarged views of parts of the securement arrangement 242.

As shown in FIG. 27, the securement arrangement 242 further comprises guides 246, the guides 246 provided on the housing 14. The guides 246 are disposed at the interfaces between the straps 244 to assist in installation and to ensure that the straps 244 remain in position once installed.

As shown in FIG. 28, the securement arrangement 242 further comprises profiled edge pieces 248, the edge pieces 248 provided on the housing 14. The edge pieces 48 are disposed at the interface between the base portion 218 and the wall portion 220. The edge pieces 248 guide the straps 244 around the interface between the base portion 18 and the wall portion 20 while avoiding sharp edges.

As shown in FIG. 29, the securement arrangement 242 further comprises buckles 249.

As shown in FIG. 30, the securement arrangement 242 further comprises a fastener 250, the fastener 250 in the safety apparatus 210 comprising a ratchet fastener, a buckle or similar appropriate joining arrangement.

1. A safety apparatus for an actuator, comprising:
a housing configured for location on an end portion of an actuator, the housing comprising a base portion and a wall portion extending from the base portion, the housing assembly defining an enclosure for encompassing the end portion of the actuator and configured to form a barrier for containing one or more component of the actuator in the event of actuator failure.

2. The safety apparatus of claim 1, wherein the housing comprises or takes the form of a bag which is at least partially constructed from a fabric material.

3. (canceled)

4. The safety apparatus of claim 1 wherein the housing is reconfigurable between a first configuration and a second, larger, configuration.

5. The safety apparatus of claim 1, wherein the housing comprises and/or is at least partially constructed from one or more materials selected from a group comprising: an aramid material, a para-aramid material, a meta-aramid material, a composite material and a polymeric material.

6. (canceled)

7. (canceled)

8. The safety apparatus of claim 1, comprising a plurality of the housings.

9. The safety apparatus of claim 1, comprising an inner housing, wherein the inner housing comprises a base portion and a wall portion, the wall portion of the inner housing extending from the base portion of the inner housing.

10. (canceled)

11. The safety apparatus of claim 9, wherein the inner housing comprises or takes the form of a bag, is at least partially constructed from a fabric material, and is reconfigurable between a first configuration and a second, larger, configuration.

12. (canceled)

13. (canceled)

14. The safety apparatus of claim 9, wherein the inner housing comprises and/or is at least partially constructed from one or more materials selected from a group comprising: an aramid material, a para-aramid material, a meta-aramid material, a composite material and a polymeric material.

15. (canceled)

16. (canceled)

17. The safety apparatus of claim 8, comprising a plurality of inner housings.

18. The safety apparatus of claim 1, comprising an indicator arrangement configured to provide an indication that failure of the actuator has occurred, the indicator arrangement comprising an indicator housing for receiving a visual indicator.

19. The safety apparatus of claim 18, wherein the indicator arrangement is interposed between an inner housing and the housing.

20. The safety apparatus of claim 18, wherein the visual indicator comprises a dye.

21. The safety apparatus of claim 18, wherein the indicator housing is configured to puncture or otherwise release the visual indicator when subjected to a force reaching a selected threshold force.

22. (canceled)

23. (canceled)

24. The safety apparatus of claim 8, comprising a plurality of indicator housings.

25. The safety apparatus of claim 18, wherein the indicator arrangement comprises a status indicator, the status indicator reconfigurable from a first configuration to a second configuration.

26. (canceled)

27. The safety apparatus of claim 1, comprising a securement arrangement configured to retain the housing on the actuator, the securement arrangement is configured for location around the housing and comprising at least one strap.

28. (canceled)

29. (canceled)

30. The safety apparatus of claim 27, wherein the strap comprises and/or is at least partially constructed from one or more materials selected from a group comprising: an Ultra-High Molecular Weight Polyethylene (UHMwPE), an aramid material, a para-aramid material and a meta-aramid material.

31. (canceled)

32. (canceled)

33. The safety apparatus of claim 27, wherein the securement arrangement comprises a plurality of straps, one or more guide, one or more profiled edge piece and a ratchet fastener.

34. (canceled)

35. (canceled)

36. (canceled)

37. An actuator assembly comprising:
an actuator; and
a safety apparatus, the safety apparatus comprising a housing configured for location on an end portion of the actuator, the housing comprising a base portion and a wall portion extending from the base portion, the housing assembly defining an enclosure for encompassing the end portion of the actuator and configured to form a barrier for containing one or more component of the actuator in the event of failure of the actuator.

38. (canceled)

39. Use of the safety apparatus according to claim 1 to resist ejection of one or more component of the actuator in the event of actuator failure.
